(19) United States
(12) Patent Application Publication
(10) Pub. No.: US 2011/0260388 A1
(43) Pub. Date: Oct. 27, 2011

(54) SHEET PROCESSING APPARATUS, SHEET PROCESSING METHOD, AND SHEET FEEDING APPARATUS

(75) Inventor: Jun ISHII, Shizuoka (JP)

(73) Assignees: Toshiba Tec Kabushiki Kaisha, Tokyo (JP); Kabushiki Kaisha Toshiba, Tokyo (JP)

(21) Appl. No.: 13/049,726

(22) Filed: Mar. 16, 2011

Related U.S. Application Data
(60) Provisional application No. 61/326,615, filed on Apr. 21, 2010.

(51) Int. Cl. B41F 13/66; B65H 9/00; B65H 1/00

(52) U.S. Cl. 270/58.07; 271/145; 271/226

(57) ABSTRACT

According to one embodiment, a sheet processing apparatus includes: a stapler configured to staple sheets conveyed from an image forming apparatus; a guide plate configured to guide the sheets to the stapler in a conveying direction of the sheets; a longitudinal alignment roller configured to rotate, when guiding the sheets to the stapler, in a first direction to longitudinally align the sheets and rotate, when discharging the sheets subjected to the finishing, in a second direction opposite to the first direction; and a pressing member, one end and the other end of which are attached to the guide plate and a main body section of which is curved in an arc shape toward the longitudinal alignment roller and is in contact with the longitudinal alignment roller.

### CROSS-REFERENCE TO RELATED APPLICATION

This application is based upon and claims the priority of U.S. Provisional Application No. 61/326,615, filed on Apr. 21, 2010, the entire contents of which are incorporated herein by reference.

### FIELD

Embodiments described herein relate generally to a sheet processing apparatus, a sheet processing method, and a sheet feeding apparatus for applying finishing to sheets discharged from an image forming apparatus such as a copying machine, a printer, or a multifunction peripheral (MFP).

### BACKGROUND

In general, a sheet processing apparatus is set adjacent to a post-stage of an image forming apparatus (e.g., a MFP) in order to apply finishing to sheets after image formation. The sheet processing apparatus is called finisher. The sheet processing apparatus staples, punches, or sorts sheets sent from the MFP and discharges the sheets.

The finisher includes a lateral alignment plate configured to control the position in the width direction of sheets and a longitudinal alignment roller configured to control the position in the longitudinal direction of the sheets. The finisher aligns the width direction and the longitudinal direction of the sheets and conveys the sheets to a finishing section (e.g., a stapler).

Besides longitudinally aligning the sheets, the longitudinal alignment roller has a function of conveying the sheets to the stapler and a function of discharging the stapled sheets. In general, the longitudinal alignment roller includes a roller for conveyance and a pinch roller configured to apply pinch pressure. However, in some case, the pinch roller cannot be set.

If the pinch roller cannot be set, in some longitudinal alignment roller, a pressing member, one end of which is fixed to a fixing member and the other end of which is projected to the conveying roller side, is used as a replacement of the pinch roller. The longitudinal alignment roller presses the pressing member against the conveying roller. However, when the stapled sheets are discharged, in some case, staples are caught by the pressing member, the pressing member is turned up, and the conveyance of the sheets is hindered. When punch holes are opened in the sheets, in some case, the pressing member is caught by the punch holes.

### BRIEF DESCRIPTION OF THE DRAWINGS

FIG. 1 is a diagram of a sheet processing apparatus according to an embodiment;

FIG. 2 is a diagram of a staple unit in the embodiment;

FIG. 3 is a perspective view of a main part of the staple unit in the embodiment;

FIG. 4 is a perspective view of the configuration of a peripheral section of a processing tray in the embodiment;

FIG. 5 is a perspective view of the configuration of a paddle in the embodiment;

FIG. 6 is a sectional view of a sheet feeding apparatus in the embodiment; and

FIG. 7 is a sectional view of the configuration of a main part of a sheet processing apparatus according to a second embodiment.

### DETAILED DESCRIPTION

In general, according to one embodiment, a sheet processing apparatus includes:

a processing tray on which sheets conveyed from an image forming apparatus are placed;

a finishing section configured to apply finishing to the sheets placed on the processing tray;

a guide plate configured to guide the sheets to the finishing section in a conveying direction of the sheets;

a sheet discharging section configured to discharge the sheets subjected to the finishing from the processing tray to a discharge port;

a longitudinal alignment roller configured to rotate, when guiding the sheets to the finishing section, in a first direction to longitudinally align the sheets and rotate, when discharging the sheets subjected to the finishing, in a second direction opposite to the first direction; and

a pressing member, one end and the other end of which are attached to the guide plate and a main body section of which is curved in an arc shape toward the longitudinal alignment rollers and is in contact with the longitudinal alignment roller.

A sheet processing apparatus according to an embodiment is explained below with reference to the accompanying drawings. The same sections in the drawings are denoted by the same reference numerals and signs.

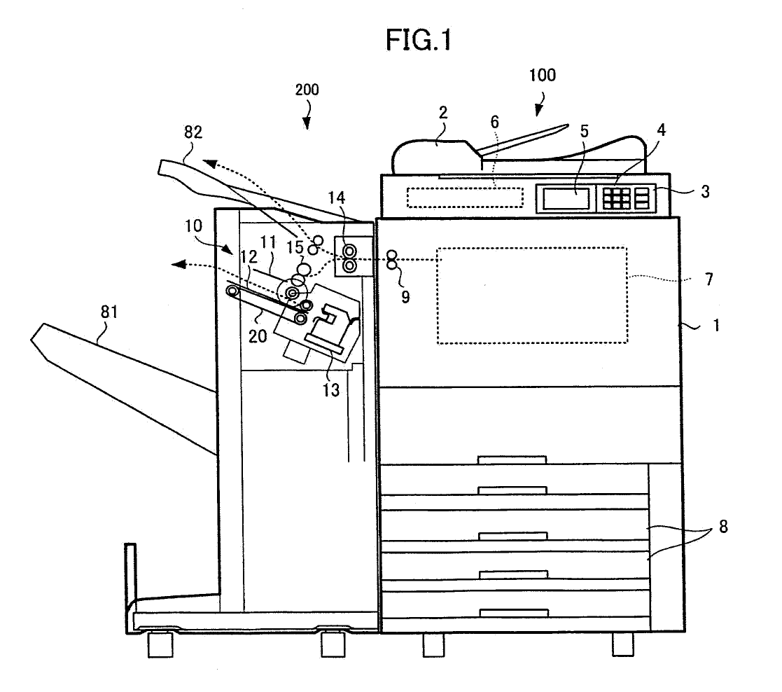

FIG. 1 is a diagram of an image forming apparatus including the sheet processing apparatus. In FIG. 1, an image forming apparatus 100 is, for example, a MFP (Multi-Function Peripheral), which is a complex machine, a printer, or a copying machine. A sheet processing apparatus 200 is arranged adjacent to the image forming apparatus 100. The sheet processing apparatus 200 is hereinafter referred to as finisher 200.

A sheet having an image formed thereon by the image forming apparatus 100 is conveyed from the image forming apparatus 100 to the finisher 200. The finisher 200 performs finishing such as stapling, sorting, or punching of sheets supplied from the image forming apparatus 100.

A document table is provided in an upper part of a main body 1 of the image forming apparatus 100. An auto document feeder (ADF) 2 is openably and closably provided on the document table. An operation panel 3 is provided in an upper part of the main body 1. The operation panel 3 includes an operation section 4 including various keys and a display section 5 of a touch panel type.

The main body 1 includes a scanner section 6 and a printer section 7 on the inside thereof. Plural cassettes 8 in which sheets of various sizes are stored are provided in a lower part of the main body 1. The scanner section 6 reads a document fed by the ADF 2 or a document placed on the document table.

The printer section 7 includes a photoconductive drum and a laser. The printer section 7 processes image data read by the scanner section 6 or image data created by a PC (personal Computer) or the like and forms an image on a sheet.

The printer section 7 scans and exposes the surface of the photoconductive drum with a laser beam from the laser and creates an electrostatic latent image on the photoconductive drum. A charging device, a developing device, a transfer device, and the like are arranged around the photoconductive drum. The electrostatic latent image on the photoconductive drum is developed by the developing device to form a toner image on the photoconductive drum. The toner image is transferred onto a sheet by the transfer device. The toner image transferred onto the sheet is fixed by a fixing device. The configuration of the printer section 7 is not limited to the example explained above. There are various types as the configuration of the printer section 7.

Sheets having images formed thereon are conveyed to the finisher 200 by a discharge roller 9. In an example shown in FIG. 1, the finisher 200 includes a staple unit 10 configured to apply stapling to a sheet bundle. The sheets subjected to the finishing by the finisher 200 are discharged to a storage tray 81 or a fixed tray 82. The storage tray 81 can be lifted and lowered.

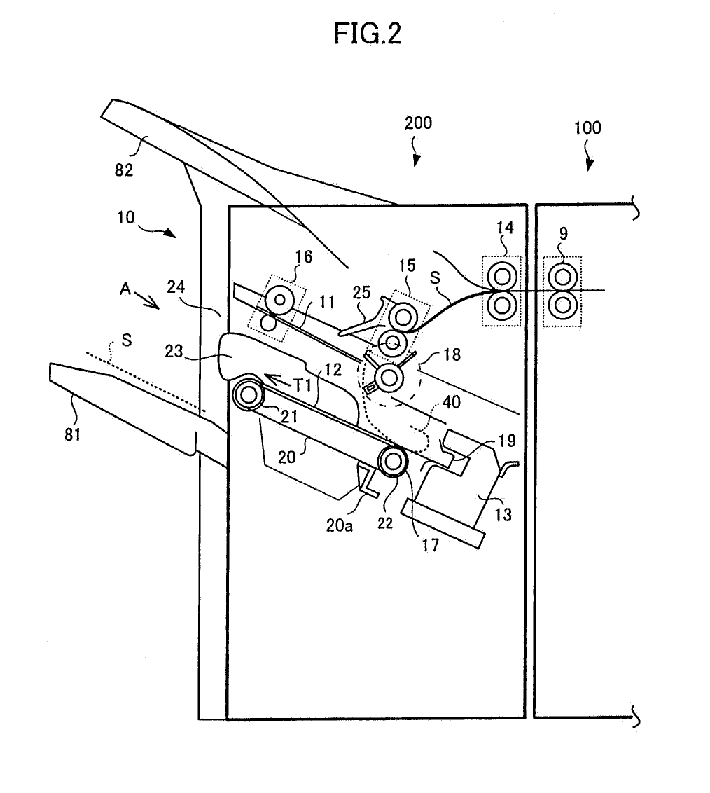

FIG. 2 is a diagram of the staple unit 10 of the finisher 200. A sheet S discharged from the discharge roller 9 of the image forming apparatus 100 is conveyed to the staple unit 10.

The staple unit 10 includes a standby tray 11, a processing tray 12, and a stapler 13. The sheet S discharged by the discharge roller 9 of the image forming apparatus 100 is received by an inlet roller 14 provided in an inlet port of the staple unit 10. The inlet roller 14 includes an upper roller and a lower roller and is driven by a motor.

A paper feeding roller 15 is provided on a downstream side of the inlet roller 14. The sheet S received by the inlet roller 14 is sent to the standby tray 11 via the paper feeding roller 15. The paper feeding roller 15 includes an upper roller and a lower roller and is driven by a motor. A processing tray 12 on which the sheet S dropped from the standby tray 11 is stacked is arranged below the standby tray 11.

The sheet S is stacked on the standby tray 11. The standby tray 11 has an openable structure. When a predetermined number of sheets S are accumulated on the standby tray 11, the standby tray 11 opens and the sheets S drop with the own weight thereof or through actuation of a drop assisting member which forcibly drop the sheets S. The processing tray 12 supports the sheets S while the sheets S are stapled by the stapler 13.

The sheets S dropped to the processing tray 12 are guided to the stapler 13 by longitudinal alignment rollers 17 and stapled. The longitudinal alignment rollers 17 rotate in one directions when the longitudinal alignment rollers 17 are driven by a motor and guide the sheets S in the direction of the stapler 13 and in the opposite direction when the longitudinal alignment rollers 17 discharge the stapled sheets S. Sheet-like pressing members 40 are provided to be opposed to the longitudinal alignment rollers 17. The sheets S are held between the longitudinal alignment rollers 17 and the pressing members 40. Details of the pressing members 40 are explained later with reference to FIG. 6.

When the plural sheets S dropped from the standby tray 11 to the processing tray 12 are stapled, the sheets S are stapled while being aligned in a longitudinal direction, which is a conveying direction of the sheets S, and aligned in a lateral direction orthogonal to the conveying direction. A lateral alignment section 23 is provided to align the sheets S in the lateral direction. The lateral alignment section 23 performs alignment and sorting of the sheets S (details are explained later). The stapler 13 configures a finishing section.

To assist the sheets S to drop to the processing tray 12, a rotatable paddle 18 is provided in a position where the trailing end of the sheets S drops. The paddle 18 is attached to a shaft. The paddle 18 taps down the sheets S, which drop from the standby tray 11, onto the processing tray 12 and feeds the sheets S in the direction of the stapler 13.

A stopper 19 configured to regulate the trailing end position of the sheets S is provided at an end on the stapler 13 side of the processing tray 12. A conveyor belt 20 is provided to convey the sorted or stapled sheets S to the storage tray 81. The conveyor belt 20 is suspended between a pulley 21 and a pulley 22. A pawl member 20a configured to hook the trailing end of the sheets S and feed the sheets S is attached to the conveyor belt 20. The pulley 22 is provided coaxially with the shaft to which the longitudinal alignment rollers 17 are attached. The longitudinal alignment rollers 17 are driven by the motor.

The conveyor belt 20 rotates in an arrow T1 direction, whereby the sheets S are discharged from a discharge port 24 to the storage tray 81. The storage tray 81 is lifted and lowered by a motor and receives the sheets S. The conveyor belt 20 and the pawl member 20a configure a sheet discharge section for guiding the stapled sheets S to the discharge port 24.

If the sheets S stacked on the standby tray 11 are discharged to the storage tray 81 without being stapled, the sheets S are discharged by a rotating roller 16 without being dropped to the processing tray 12. The sheets S not requiring stapling can also be discharged to the fixed tray 82. A conveying path is provided to guide the sheets S to the fixed tray 82.

An assist arm 25 is swingably attached to an attachment shaft for the upper roller of the paper feeding roller 15. The assist arm 25 projects to a discharge side of the paper feeding roller 15. The assist arm 25 presses the trailing end side of the sheets S discharged from the paper feeding roller 15 against the standby tray 11 to prevent the trailing end side from lifting.

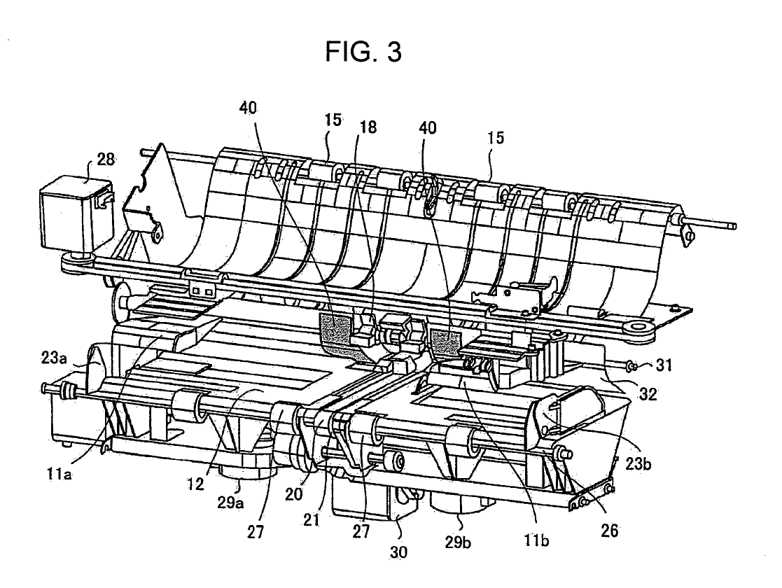

FIG. 3 is a perspective view of a main part of the staple unit 10 and is a view from an arrow A direction in FIG. 2. In FIG. 3, the standby tray 11, the processing tray 12, the paddle 18, and mechanisms around these components are mainly shown.

In FIG. 3, a shaft 26 is arranged orthogonal to the conveying direction of the sheets S. The pulley 21 is attached in the middle of the shaft 26. The conveyor belt 20 is laid over the pulley 21. The conveyor belt 20 is suspended between the pulley 21 and the pulley 22 (FIG. 2). The conveyor belt 20 is rotated by a motor 30 and cyclically rotates between the stapler 13 and the discharge port 24 along a discharge direction of the sheets S. Discharge rollers 27 are attached to the center and both sides of the shaft 26. The discharge rollers 27 rotate when the sheets S are discharged to the storage tray 81.

The standby tray 11 includes a pair of tray members 11a and 11b and supports both the ends in the width direction of the sheets S. The tray members 11a and 11b can be moved in the width direction of the sheets S by a motor 28. The lateral alignment section 23 is provided in the processing tray 12.

The lateral alignment section 23 includes a pair of lateral alignment plates 23a and 23b provided on both sides of the processing tray 12. The tray members 11a and 11b and the lateral alignment plates 23a and 23b can slide in the width direction of the sheets S. The lateral alignment plates 23a and 23b align the sheets S dropped from the tray members 11a and 11b. the lateral alignment plates 23a and 23b are moved in a direction parallel to the shaft 26 by motors 29a and 29b.

A shaft 31 is provided on the stapler 13 side in parallel to the shaft 26. The paddle 18 is rotatably attached to the shaft 31. A guide plate 32 is provided near the paddle 18. The guide plate 32 guides the sheets S to the stapler 13 along from upstream to downstream in the conveying direction. The guide plate 32 is curved to guide the trailing end of the sheets S in the direction of the stapler 13 (see FIG. 6). A portion of the guide plate 32 where the paddle 18 is located is cut out. The pressing members 40 are attached to both sides of the portion of the guide plate 32 where the paddle 18 is located.

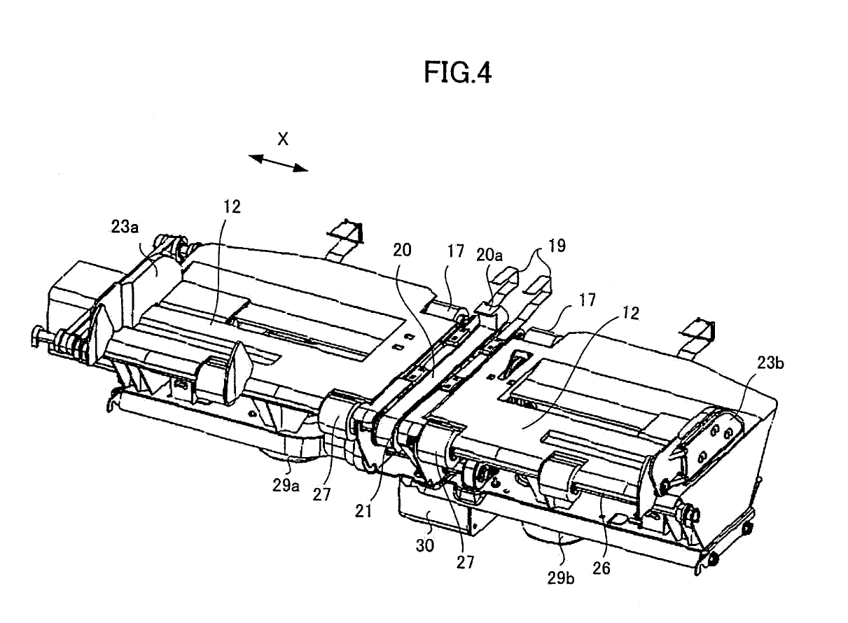

FIG. 4 is a perspective view of the configuration of a peripheral section of the processing tray 12. The lateral alignment plates 23a and 23b are provided on both sides of the processing tray 12 to be movable in an arrow X direction. The conveyor belt 20 is provided in the center of the processing tray 12. The motor 30 configured to drive the conveyor belt 20 and the motors 29a and 29b configured to drive the lateral alignment plates 23a and 23b in the arrow X direction are provided. The longitudinal alignment rollers 17 are attached to both sides of the conveyor belt 20 on the stapler 13 side.

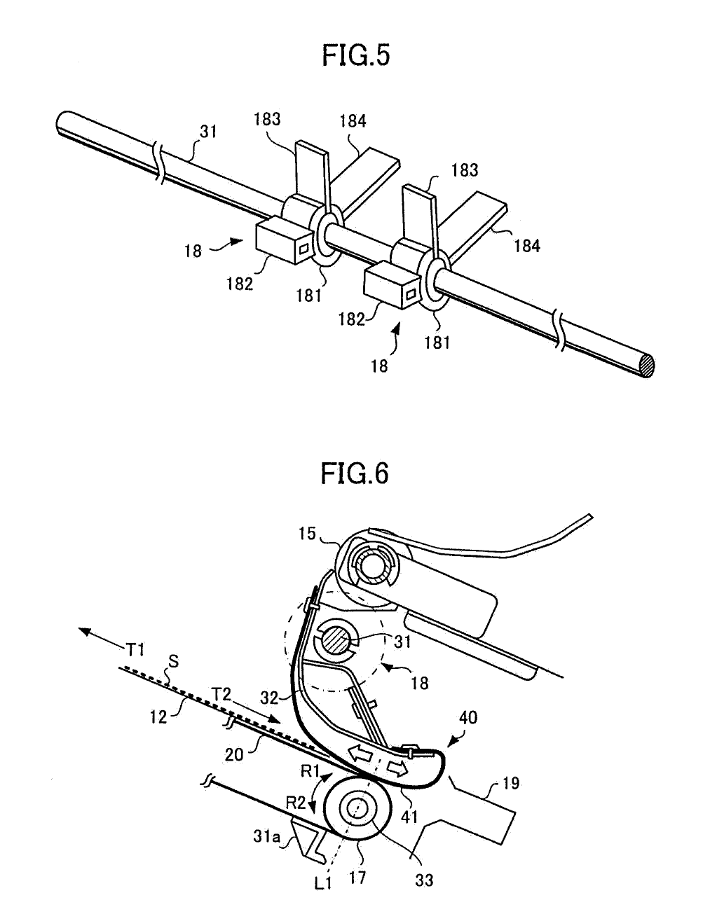

FIG. 5 is a perspective view of the configuration of the paddle 18. In the paddle 18, attachment members 181 are attached to the shaft 31. Receiving sections 182 configured to receive the trailing end of the sheets S dropping from the standby tray 11, slapping sections 183 configured to tap down the sheets S onto the processing tray 12, and feeding sections 184 configured to feed the sheets S on the processing tray 12 in the direction of the stapler 13 are fixed to the attachment members 181. The slapping sections 183 and the feeding sections 184 of the paddle 18 are made of a rubber material and have elasticity. The shaft 31 is driven to rotate by a motor. Alternatively, rotating force of the motor may be transmitted to the shaft 31 via a gear mechanism.

FIG. 6 is a sectional view of a sheet feeding apparatus including the paddle 18 and the longitudinal alignment rollers 17. The paddle 18 is attached to the shaft 31. The longitudinal alignment rollers 17 are attached to a shaft 33.

The sheet-like pressing members 40 having elasticity are attached to the guide plate 32. One ends of the pressing members 40 are attached to the upper end of the guide plate 32. The other ends of the pressing members 40 are attached to the lower end of the guide plate 32. Main body sections 41 of the pressing members 40 are curved to draw an arc with respect to the longitudinal alignment rollers 17 and are in contact with the longitudinal alignment rollers 17.

In FIG. 6, if the sheets S on the processing tray 12 are fed in the direction (an arrow T2) of the stapler 13, the longitudinal alignment rollers 17 rotate clockwise (in an R1 direction). If the sheets S on the processing tray 12 are discharged, the longitudinal alignment rollers 17 rotate counterclockwise (in an R2 direction). The longitudinal alignment rollers 17 and the discharge rollers 27 (see FIGS. 3 and 4) are driven to rotate by the motors and rotate together.

In the finisher according to the embodiment, the pressing members 40 are arranged to be opposed to the longitudinal alignment rollers 17. The sheets S are held between the longitudinal alignment rollers 17 and the pressing members 40. The longitudinal alignment rollers 17 are rotated to convey the sheets S to the stapler 13 side and convey the stapled sheets S to the discharge port 24.

As shown in FIG. 6, a line connecting the rotation centers of the longitudinal alignment rollers 17 and points where the pressing members 40 are in contact with the longitudinal alignment rollers 17 is represented as L1. Ends on the upstream side of the pressing members 40 are joined to the upper end of the guide plate 32. Ends on the downstream side of the pressing members 40 are joined to the lower end of the guide plate 32. The pressing members 40 swell to draw an arc to the longitudinal alignment rollers 17 side, generate pinch pressure with elastic force of the pressing members 40, and come into contact with the longitudinal alignment rollers 17.

Therefore, when the longitudinal alignment rollers rotate, the sheets S are pressed against the longitudinal alignment rollers 17 by the elastic force of the pressing members 40. Since both the ends of the pressing members 40 are joined to the guide plate 32, when the sheets S are conveyed to the stapler 13 and when the sheets S are stapled and discharged, the sheets S are not caught by the pressing members 40 and staples are not caught by the pressing members 40.

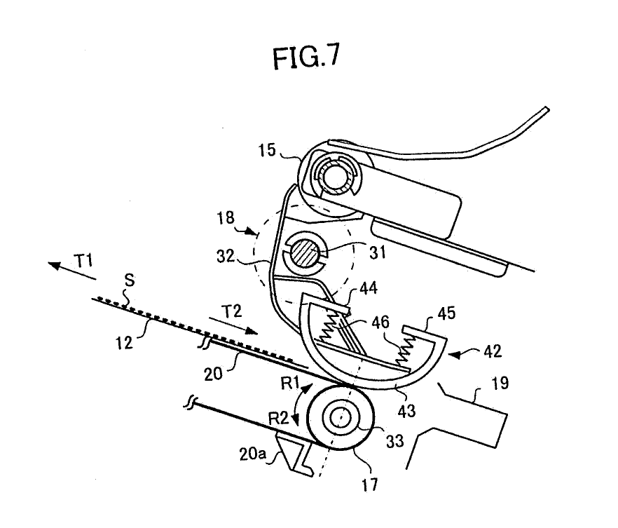

FIG. 7 is a sectional view of the configuration of a main part (a sheet feeding apparatus) of a sheet processing apparatus according to a second embodiment.

In the second embodiment, rigid pressing members 42 are used instead of the pressing members 40. The pressing members 42 include semicircular main bodies 43 and supporting sections 44 and 45 formed inward on both sides of the main bodies 43. Springs 46 are respectively attached between the supporting members 44 and the guide plate 32 and between the supporting sections 45 and the guide plate 32. The pressing members 42 are pressed against the longitudinal alignment rollers 17 by the own weight of the pressing members 42 and the force of the springs 46.

Therefore, arc surfaces of the pressing members 42 are always in contact with the longitudinal alignment rollers 17. In the second embodiment, since both ends of the pressing members 42 are joined to the guide plate 32, when the sheets S are conveyed to the stapler 13 and when the sheets S are stapled and discharged, the sheets S are not caught by the pressing members 42 and staples are not caught by the pressing members 42.

According to the embodiments explained above, when sheets are longitudinally aligned and guided to the finishing section (the stapler) and when the sheets are discharged from the finishing section, the sheets can be smoothly conveyed.

Various modifications are possible without being limited to the embodiments. For example, in the example explained above, longitudinally-aligned sheets are stapled. However, another kind of finishing (punching, etc.) may be applied to the longitudinally-aligned sheets.

While certain embodiments have been described, these embodiments have been presented by way of example only, and are not intended to limit the scope of the invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A sheet processing apparatus comprising:
a processing tray on which sheets conveyed from an image forming apparatus are placed;
a finishing section configured to apply finishing to the sheets placed on the processing tray;
a guide plate configured to guide the sheets to the finishing section in a conveying direction of the sheets;
a sheet discharging section configured to discharge the sheets subjected to the finishing from the processing tray to a discharge port;
a longitudinal alignment roller configured to rotate, when guiding the sheets to the finishing section, in a first direction to longitudinally align the sheets and rotate, when discharging the sheets subjected to the finishing, in a second direction opposite to the first direction; and
a pressing member, one end and the other end of which are attached to the guide plate and a main body section of which is curved in an arc shape toward the longitudinal alignment roller and is in contact with the longitudinal alignment roller.

2. The apparatus of claim 1, wherein the finishing section is a stapler configured to staple the sheets.

3. The apparatus of claim 1, wherein the pressing member is a sheet member having elasticity, one end of the sheet member is fixed to an upstream side of the guide plate, the other end of the sheet member is fixed to a downstream side of the guide plate, and a main body section of the sheet member is curved in an arc shape to the roller side and set in contact with the longitudinal alignment roller.

4. The apparatus of claim 1, wherein the pressing member is a semicircular member, one end of the semicircular member is supported on an upstream side of the guide plate, the other end of the semicircular member is supported on a downstream side of the guide plate, and a main body section of the semicircular member is set in contact with the longitudinal alignment roller.

5. The apparatus of claim 4, wherein the semicircular member is rigid.

6. The apparatus of claim 4, wherein the semicircular member is supported on the guide plate by a spring to set the main body section in contact with the longitudinal alignment roller.

7. The apparatus of claim 1, further comprising a rotatable paddle configured to slap down the sheets, which are conveyed from the image forming apparatus, to the processing tray, wherein
the pressing member is attached on each of both sides of the paddle.

8. A sheet processing method comprising:
placing sheets conveyed from an image forming apparatus on a processing tray;
providing a guide plate configured to guide the sheets to a finishing section in a conveying direction of the sheets;
rotating a longitudinal alignment roller in a first direction to longitudinally align the sheets when guiding the sheets on the processing tray to the finishing section, and subjecting the longitudinally-aligned sheets to finishing with the finishing section;
rotating the longitudinal alignment roller in a second direction opposite to the first direction and discharging the sheets subjected to the finishing from the processing tray to a discharge port; and
attaching one end and the other end of a pressing member to the guide plate, curving a main body section of the pressing member in an arc shape toward the longitudinal alignment roller, and holding the sheets between the roller and the main body section and conveying the sheets.

9. The method of claim 8, wherein the finishing section is a stapler configured to staple the sheets.

10. The method of claim 8, wherein
the pressing member is a sheet member having elasticity,
one end of the sheet member is fixed to an upstream side of the guide plate,
the other end of the sheet member is fixed to a downstream side of the guide plate, and
a main body section of the sheet member is curved in an arc shape to the roller side and set in contact with the longitudinal alignment roller.

11. The method of claim 8, wherein
the pressing member is a semicircular member,
one end of the semicircular member is supported on an upstream side of the guide plate,
the other end of the semicircular member is supported on a downstream side of the guide plate, and
a main body section of the semicircular member is set in contact with the longitudinal alignment roller.

12. The method of claim 11, wherein the semicircular member is rigid.

13. The method of claim 8, wherein the semicircular member is supported on the guide plate by a spring to set the main body section in contact with the longitudinal alignment roller.

14. The method of claim 8, further comprising:
providing a rotatable paddle configured to slap down the sheets, which are conveyed from the image forming apparatus, to the processing tray; and
attaching the pressing member on each of both sides of the paddle.

15. A sheet feeding apparatus comprising:
a finishing section configured to apply finishing to sheets;
a guide plate configured to guide the sheets to the finishing section in a conveying direction of the sheets;
a sheet discharging section configured to discharge the sheets subjected to the finishing from the processing tray to a discharge port;
a longitudinal alignment roller configured to rotate, when guiding the sheets to the finishing section, in a first direction to longitudinally align the sheets and rotate, when discharging the sheets subjected to the finishing, in a second direction opposite to the first direction; and
a pressing member, one end and the other end of which are attached to the guide plate and a main body section of which is curved in an arc shape toward the longitudinal alignment roller and is in contact with the longitudinal alignment roller.

16. The apparatus of claim 15, wherein the finishing section is a stapler configured to staple the sheets.

17. The apparatus of claim 15, wherein the pressing member is a sheet member having elasticity, one end of the sheet member is fixed to an upstream side of the guide plate, the other end of the sheet member is fixed to a downstream side of the guide plate, and a main body section of the sheet member is curved in an arc shape to the roller side and set in contact with the longitudinal alignment roller.

18. The apparatus of claim 15, wherein the pressing member is a semicircular member, one end of the semicircular member is supported on an upstream side of the guide plate, the other end of the semicircular member is supported on a downstream side of the guide plate, and a main body section of the semicircular member is set in contact with the longitudinal alignment roller.

19. The apparatus of claim 18, wherein the semicircular member is rigid.

20. The apparatus of claim 15, wherein the semicircular member is supported on the guide plate by a spring to set the main body section in contact with the longitudinal alignment roller.
